(19) United States
(12) Patent Application Publication
(10) Pub. No.: US 2010/0330344 A1
(43) Pub. Date: Dec. 30, 2010

(54) METHOD FOR MAKING KEY PANEL AND KEY PANEL THEREOF

(75) Inventors: HONG-BO LI, Shenzhen City (CN); YAN-MIN WANG, Shenzhen City (CN); GANG HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/698,109

(22) Filed: Feb. 1, 2010

(30) Foreign Application Priority Data
Jun. 26, 2009 (CN) 200910303757.7

(51) Int. Cl. B32B 3/00; B29C 59/00

(52) U.S. Cl. 428/173; 264/129

(57) ABSTRACT

A method for making key panel comprises the following steps: molding a transparent or translucent substrate, forming a plurality of grooves in the substrate during the molding of the substrate; filling the grooves with ink; and forming a translucent metallic coating on the surface of the substrate and covering the ink. A key panel made by the above mentioned method is also described there.

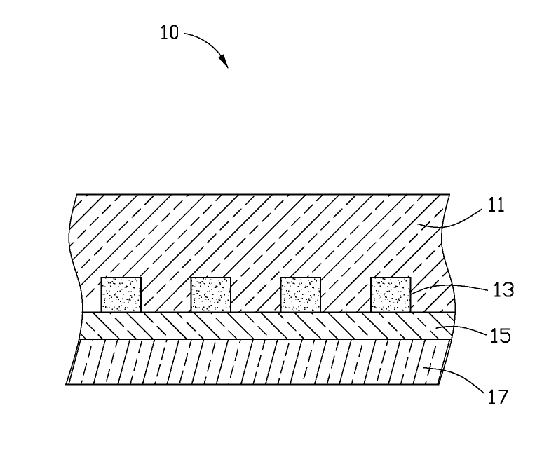

### CROSS-REFERENCE TO RELATED APPLICATIONS

This application is related to co-pending U.S. patent application (Attorney Docket No. US26991), entitled “METHOD FOR MAKING KEY PANEL AND KEY PANEL THEREOF”. Such application has the same assignee as the present application. The above-identified application is incorporated herein by reference.

### BACKGROUND

1. Technical Field

The present disclosure relates to methods for making key panels, especially to a method for making key panels having three-dimensional key patterns and metallic appearance, and a key panel.

2. Description of Related Art

Key panels of portable electronic devices are commonly made of plastic. Plastic key panels commonly include key patterns formed on the key panels' surface by printing ink. These key patterns typically cannot present a three-dimensional appearance. Furthermore, the plastic key panels typically do not have metallic appearances. If, however, metal is used to manufacture the key panels having metallic appearances, the weight of the key panels increases as dose the cost.

Therefore, there is room for improvement within the art.

### BRIEF DESCRIPTION OF THE FIGURE

Many aspects of the key panel can be better understood with reference to the following FIGURE. The components in the FIGURE are not necessarily drawn to scale, the emphasis instead being placed upon clearly illustrating the principles of the key panel.

The FIGURE is a cross-sectional view of an exemplary embodiment of a key panel.

### DETAILED DESCRIPTION

In an exemplary embodiment, a method for making a key panel may comprise molding a transparent or translucent substrate, the substrate defining a plurality of grooves formed during the molding of the substrate; filling the grooves with ink; and forming a translucent metallic coating on the surface of the substrate and covering the ink.

Referring to the FIGURE, a substrate 11 is molded in a mold using plastic. The plastic of molding the substrate 11 may be selected from a group consisting of polypropylene (PP), polyamide (PA), polycarbonate (PC), polymethyl methacrylate (PMMA), and polyethylene terephthalate (PET). The thickness of the substrate 11 may be about 0.4-1 mm. The mold (not shown) has a cavity with a pre-defined grooved surface bounding a portion thereof; accordingly, one surface of the substrate 11 will be formed with a corresponding plurality of grooves 13 therein during the molding process. The grooves 13 may define the shape of the numbers, letters and patterns of the key panel. The depth of each groove may be about 8-12 μm.

The grooves 13 are then filled with ink to form the numbers, letters and patterns of the key panel. The ink may be acrylic resin ink. The ink can be black or colorized. After the grooves 13 are filled, the numbers, letters and patterns of the key panel have a three-dimensional appearance (when observed from the surface of the substrate 11 opposite to the grooves 13).

A translucent metallic coating 15 is applied by vacuum deposition on the surface of the substrate 11 and covering the ink filled in the grooves 13. The material used for the metallic coating 15 can be selected from copper or gold to give a golden appearance, or selected from aluminum or indium to give an argent appearance. The metallic coating 15 can be translucent and can let light pass through by choosing the above-mentioned materials and/or by controlling the thickness of the metallic coating 15 to a range of about 20-100 nm.

An optional transparent or translucent protective coating 17 may be applied on the exposed surface of the metallic coating 15. The protective coating 17 can be an ultraviolet curing paint coating or a hot curing paint coating formed by spraying, or an ink coating formed by printing. The protective coating 17 can protect the metallic coating 15 from being abrasion.

Referring to the FIGURE, a key panel 10 made by the above mentioned method includes a substrate 11, a translucent metallic coating 15 and a protective coating 17. The substrate 11 may be transparent or translucent. One surface of the substrate 11 has a plurality of grooves 13. The grooves 13 may define the shape of the numbers, letters and patterns of the key panel 10. The grooves 13 is then filled with black or colorized ink to form the numbers, letters and patterns of the key panel 10. The metallic coating 15 is formed on the surface of the substrate 11 and covering the ink. The protective coating 17 may be transparent or translucent, and is formed on the metallic coating 15.

The exemplary method of forming grooves 13 on one surface of the substrate 11 during the molding of the substrate 11 and then filling the grooves 13 with ink to form three-dimensional numbers, letters and patterns (key patterns) of the key panel 10, and further applying a metallic coating 15 on the surface of the substrate 11 and covering the ink filled in the grooves 13, which gives the key panel 10 an attractive metallic appearance (when observed from the surface of the substrate 11 opposite to the grooves 13).

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A method for making a key panel, comprising:
molding a transparent or translucent substrate, forming a plurality of grooves in the substrate during the molding of the substrate;
filling the grooves with ink; and
forming a translucent metallic coating on the surface of the substrate and covering the ink.

2. The method as claimed in claim 1, wherein the substrate is made of plastic selected from a group consisting of polypropylene, polyamide, polycarbonate, polymethyl methacrylate, and polyethylene terephthalate.

3. The method as claimed in claim 1, wherein the metallic coating is formed by vacuum deposition.

4. The method as claimed in claim 3, wherein the metallic coating has a thickness of about 20-100 nm.

5. The method as claimed in claim 1, wherein the metallic coating is a copper coating, a gold coating, an aluminum coating or an indium coating.

6. The method as claimed in claim 1, wherein each groove has a depth of about 8-12 μm.

7. The method as claimed in claim 1, further comprising forming a protective coating on the metallic coating.

8. The method as claimed in claim 7, wherein the protective coating is a paint coating or an ink coating.

9. A key panel, comprising:
a transparent or translucent substrate, the substrate being formed by a molding process, one surface of the substrate having a plurality of grooves formed therein during the molding process, the grooves filled with ink; and
a translucent metallic coating formed on the surface of the substrate and covering the ink.

10. The key panel as claimed in claim 9, wherein the substrate is made of plastic selected from a group consisting of polypropylene, polyamide, polycarbonate, polymethyl methacrylate, and polyethylene terephthalate.

11. The key panel as claimed in claim 9, wherein the metallic coating is formed by vacuum deposition.

12. The key panel as claimed in claim 11, wherein the metallic coating has a thickness of about 20-100 nm.

13. The key panel as claimed in claim 9, wherein the metallic coating is a copper coating, a gold coating, an aluminum coating or an indium coating.

14. The key panel as claimed in claim 9, wherein each groove has a depth of about 8-12 μm.

15. The key panel as claimed in claim 9, wherein the key panel further includes a protective coating applied on the metallic coating.

16. The key panel as claimed in claim 15, wherein the protective coating is a paint coating or an ink coating.
